(19) United States
(12) Patent Application Publication
(10) Pub. No.: US 2014/0339921 A1
(43) Pub. Date: Nov. 20, 2014

(54) Light Load Current Detection System

(71) Applicant: Feeling Technology Corp., Chupei City (TW)

(72) Inventors: Ming-Yu HSU, Chupei City (TW); Wei-Chung LIU, Chupei City (TW)

(73) Assignee: Feeling Technology Corp., Chupei City (TW)

(21) Appl. No.: 13/960,563

(22) Filed: Aug. 6, 2013

(30) Foreign Application Priority Data
May 17, 2013 (TW) 102117489

(51) Int. Cl. H02J 4/00

(52) U.S. Cl. CPC H02J 4/00
USPC 307/131

(57) ABSTRACT

A light load current detection system including a detection process module and a control circuit is provided for detecting a current value of a light load current of a load in a light load mode; the detection process module including a power save unit and a voltage detection module. The power save unit sends a power save signal, wherein a cycle of the power save signal corresponds to a switch state. The voltage detection module detects an input voltage value to generate and output a detection signal. The control circuit includes a data table and a threshold, the data table showing a relation among the cycle, the current value and the input voltage value. The control circuit determines if the current value reaching the threshold, the switch is turned off in the light load module.

This application claims the benefits of the Taiwan Patent Application Serial NO. 102117489 filed on May 17, 2013, the subject matter of which is incorporated herein by reference.

### BACKGROUND OF THE INVENTION

1. Field of the Invention

The present invention relates to a light load current detection system and more particularly, relates to a light load current detection system determining whether a current value of a light load current reaching a threshold and then determining whether to switch off a switch.

2. Description

In terms of the efficiency of a power switch for a mobile charger, nowadays people value more on both full and light loads efficiency at the same time rather than full but heavy loads. Usually when a user charges his/her cellphone with a power adaptor, he/she will have to remove the power adaptor by himself/herself after seeing the screen of the cellphone showing that the phone has been fully charged, which is very inconvenient.

When applying a light load current detection to a mobile charger, it is more convenient and useful for a user. More specifically, with the assistance of a Micro Control Unit (MCU) in the mobile charger, an application circuit is utilized for detecting whether the cellphone is fully charged; after the cellphone is fully charged, the MCU will inform the application circuit to cut off the power, so that the system of the cellphone enters energy-saving mode or sleep mode.

However, present application circuits with the light load current detection require certain components. For example, in the market, an amplifier circuit is utilized to amplify signals generated from the conversion of a load current into a voltage and to send the amplified signals to a processor. However, there are disadvantages in this method: 1) Since the signals of voltages are weak, a precision amplifier with low offset is required; however, the usage of precision amplifier with low offset increases the cost and size; as a result, it is a challenge for developing a light-weighted and small-sized product. 2) A sensing resistance is required to convert the load current into the voltage; however, the usage of the sensing resistance easily causes energy-loss and low conversion efficiency.

### SUMMARY OF THE INVENTION

In prior art, most application circuits have disadvantages such as high cost, waste of space and low conversion efficiency. Thus, a light load current detection system is provided according to embodiments of the present invention, in which a pre-simulated data table is stored in an application circuit and a current value of the light load current is detected according to the data table so as to determine whether to switch off a switch or not.

A light load current detection system is provided according to an embodiment of the present invention for detecting a current value of a light load current of a load in a light load mode, the load electrically connecting a switch, the light load current detection system including a detection process module and a control circuit. The detection process module electrically connects an input voltage source and electrically connected to the load via the switch, the detection process module including a power save unit and a voltage detection module. The power save unit sends a power save signal in the light load mode, wherein a cycle of the power save signal corresponds to a switch time. The voltage detection module electrically connects the input voltage source for detecting an input voltage value of the input voltage source to generate and output a detection signal.

The control circuit includes a data table and a threshold, the data table shows a relation among the cycle, the current value and the input voltage value, the control circuit electrically connects the power save unit, the voltage detection module and the switch for receiving the power save signal and the detection signal, obtaining the current value according to the data table, the cycle and the input voltage value, and determining whether the current value reaching the threshold, wherein when the control circuit determines the current value reaches the threshold, the switch is turned off in the light load module.

A light load current detection is provided according to anther embodiment of the present invention, which is different from the above embodiment in that the power save unit electrically connects a power switch and sends a power save signal. Furthermore, a cycle of the power save signal corresponds to a switch state, wherein the switch state includes a switch time and a switch pulse number. The cycle is determined by the ratio of switch time and non-switch time of the power switch or determined by the number of switch pulse number of the power switch. As a result, the control circuit obtains the current value according to the data table, the cycle and the input voltage value, and determining whether the current value reaching the threshold, wherein when the control circuit determines the current value reaches the threshold, the switch is turned off in the light load module.

According to embodiments of the present invention, the control circuit includes a Micro Control Unit (MCU). The detection process module further includes an activation input end, the control circuit electrically connecting the detection process module via the activation input end, when the control circuit determines the current value reaches the threshold, the control circuit simultaneously outputs a switch-off signal to the activation input end so as to turn off the detection process module. The load is selected from the group of a cellphone, a tablet computer and a laptop computer.

Accordingly, precision amplifier and sensing resistance are no longer required. Instead, merely a data table is required for the detection of light load currents. Thus, the problems of high cost, waste of space and low conversion efficiency no longer bother.

### BRIEF DESCRIPTION OF THE DRAWINGS

Other features and advantages of this invention will become more apparent in the following detailed description of the preferred embodiments of this invention, with reference to the accompanying drawings.

FIG. 1 is a schematic view of a light load current detection system according to a first embodiment of the present invention.

FIG. 2 is a schematic circuit diagram of the light load current detection system according to the first embodiment of the present invention.

FIG. 3 is a schematic view of a data table according to embodiments of the present invention.

FIG. 4 is a schematic view of a light load current detection system according to a second embodiment of the present invention.

FIG. 5 is a diagram comparing a waveform of a power switch detection signal and a waveform of a power save signal.

### DETAILED DESCRIPTION OF THE PREFERRED EMBODIMENT

The present invention relates to a light load current detection system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

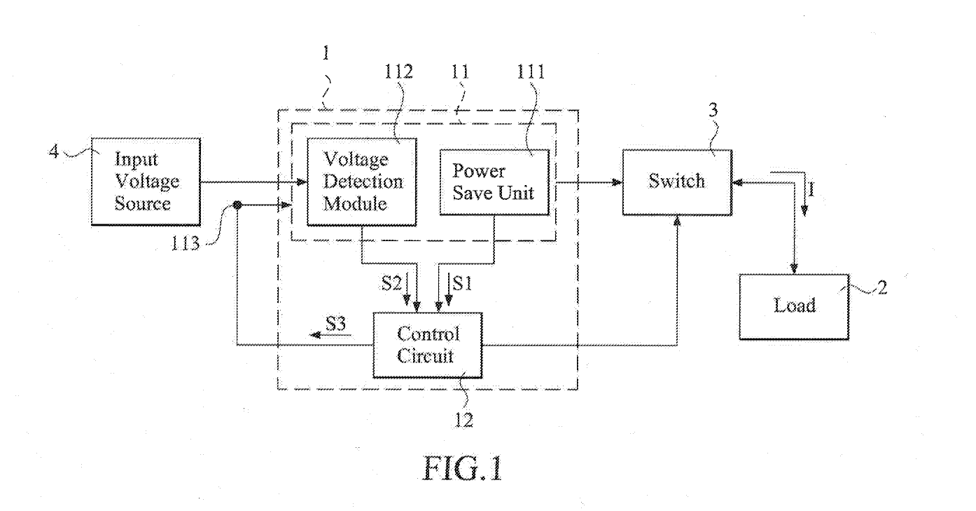

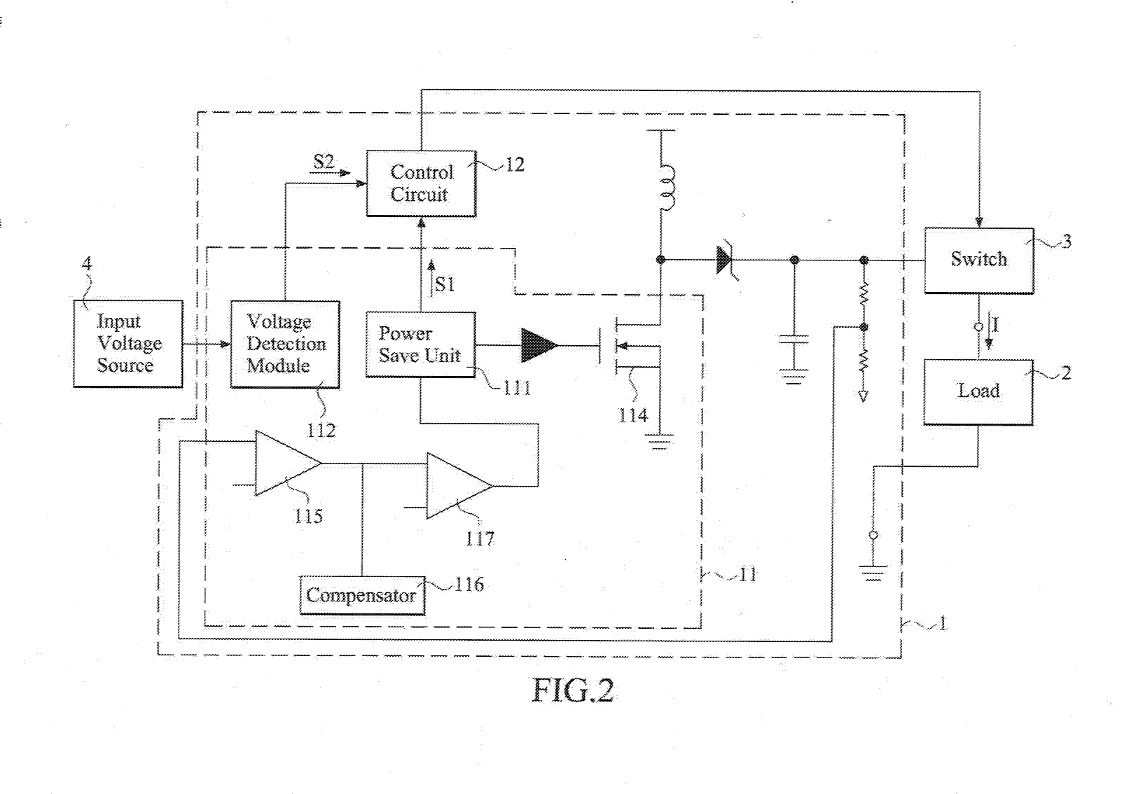

Refer to FIG. 1 and FIG. 2. FIG. 1 is a schematic view of a light load current detection system according to a first embodiment of the present invention. FIG. 2 is a schematic circuit diagram of the light load current detection system according to the first embodiment of the present invention. A light load current detection system 1 is provided according to the first embodiment of the present invention for detecting a current value of a light load current I of a load 2 in a light load mode, the load 2 electrically connecting a switch 3, wherein the load 2 is selected from the group of a cellphone, a tablet computer and a laptop computer.

The light load current detection system 1 including a detection process module 11 and a control circuit 12, the detection process module 11 electrically connecting an input voltage source 4 and electrically connected to the load 2 via the switch 3, wherein the detection process module 11 includes a processing circuit for DC to DC.

The detection process module 11 electrically connects the switch 3 via an inductance (not shown), a diode (not shown), a capacitance (not shown) and two resistances (not shown). The design of its circuit varies according to various usages. The detection process module 11 includes a power save unit 111, a voltage detection module 112, an activation input end 113, a power switch 114, a comparator 115 and compensator 116 and a compensation comparator 117.

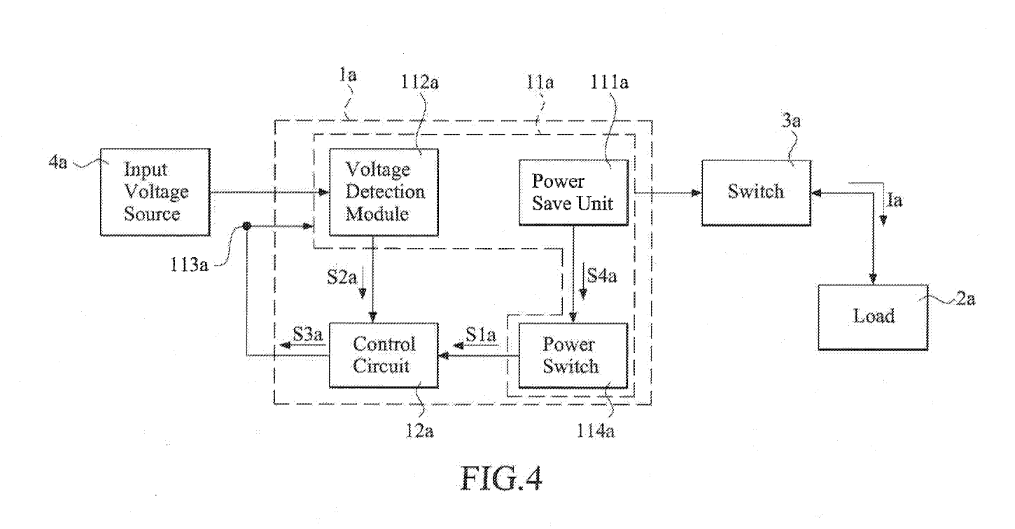

The power save unit 111 includes an ordinary circuit; the voltage detection module 112 includes a present circuit for detecting voltage; the detection module 112 electrically connects the input voltage source 4. The activation input end 113 can be one of an input pin of the detection process module. The power switch 114 (same as a power switch 114a of FIG. 4) will be described in the second embodiment of the present invention. The comparator 115 receives a feedback voltage related to the load 2 from voltage divisions of the two resistances. The comparator 115 includes a voltage comparison value for being compared with the feedback voltage. The compensator 116 electrically connects the comparator 115 and the compensator 116 includes an ordinary compensation circuit. The compensation comparator 117 electrically connects the comparator 115 and the compensator 116. The compensation comparator 117 includes an ordinary comparator.

The control circuit 12 electrically connects the power save unit 111, the voltage detection module 112 and the switch 3. According to the first embodiment of the present invention, the control circuit 12 electrically connects the detection process module 11 via the activation input end 113. The control circuit 12 includes a Micro Control Unit (MCU). In other embodiments of the present invention, the control circuit 12 includes a Complex Programmable Logic Device (CPLD) and an Application-Specific Integrated Circuit (ASIC).

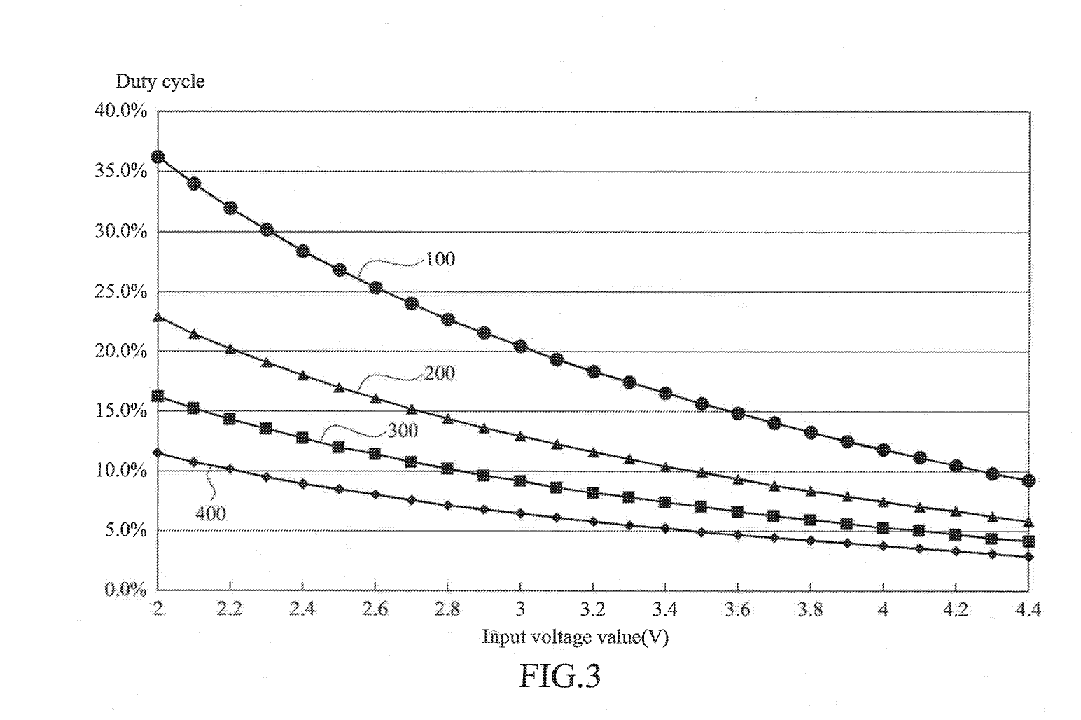

Please refer to FIG. 3. FIG. 3 is a schematic view of a data table according to embodiments of the present invention. The power save unit 111 sends a power save signal S1 in the light load mode, wherein a cycle of the power save signal S1 corresponds to a non-switch time. More specifically, according to the first embodiment of the present invention, as shown in FIG. 3, the cycle is defined as a duty cycle of the power save signal S1 and the ratio of the cycle corresponds to a non-switch time of the light load current detection system 1. In other embodiments, the cycle can be corresponding to a time when the power switch 114 is cut-off. The corresponding relation between the cycle and the non-switch time can be pre-simulated by a simulation software.

According to the first embodiment of the present invention, the power save signal S1 is relevant with the load 2. The relation between the power save signal S1 and load 2 is that the power save signal S1 is determined by the following process: the feedback voltage fed from the load 2 is firstly compared with the comparator 115, and the output signal of comparator 115 compensated by the compensator 116, and the power save signal S1 is determined by compensation comparator 117.

The voltage detection module 112 detects an input voltage value of the input voltage source 4, generates and outputs a detection signal S2 accordingly. The detection signal S2 represents the mentioned input voltage value. The control circuit 12 includes a data table (as shown in FIG. 3) and a threshold, the data table showing a relation among the cycle, the current value of the light load current I, and the input voltage value. The data table can be pre-simulated by a simulation software and the threshold can be determined according to practical needs.

The control circuit 12 receives the power save signal S1 and the detection signal S2, obtains the current value of the light load current I according to the data table, the cycle and the input voltage value, and determines whether the current value reaching the threshold, wherein when the control circuit 12 determines the current value reaches the threshold, the switch 3 is turned off in the light load module. For example, a preferred method of turning off the switch 3 is to make the control circuit 12 send a turning-off signal to the switch 3.

According to FIG. 3, Curve 100 shows the relation among a current value of 5 mA, the cycle and the input voltage value; Curve 200 shows the relation among a current value of 10 mA, the cycle and the input voltage value; Curve 300 shows the relation among a current value of 20 mA, the cycle and the input voltage value; Curve 400 shows the relation among a current value of 50 mA, the cycle and the input voltage value. The control circuit 12 determines the current value of the light load current I according to the data table. For example, when the input voltage value is 4V and the control circuit 12 detects that the cycle is lower than 7.5%, then the corresponding current value of the light load current I is determined as 10 mA. As a result, when the threshold is 10 mA, the control circuit 12 switches off the switch 3 and enters an energy-saving mode or sleep mode.

Furthermore, when the control circuit 12 determines the current value reaching the threshold, the control circuit 12 simultaneously outputs a switch signal S3 to the activation input end 113, switches off the detection process module 11, and switches off the light load current detection system 1 so as to further decrease the energy consumption.

Refer to FIG. 4. FIG. 4 is a schematic view of a light load current detection system according to a second embodiment of the present invention. The difference between the first and the second embodiments is that in the second embodiment, a detection process module 11a of a light load current detection system 1a detects the light load current not only with a power save unit 111a, a voltage detection module 112a, an activation input end 113a, but also a power switch 114a. The power switch 114a electrically connects with the power save unit 111a and a control circuit 12. Since the function of the power switch 114a is the same as that of the power switch 114 in the first embodiment of the present invention, the power switch 114a will be given more description in the second embodiment of the present invention.

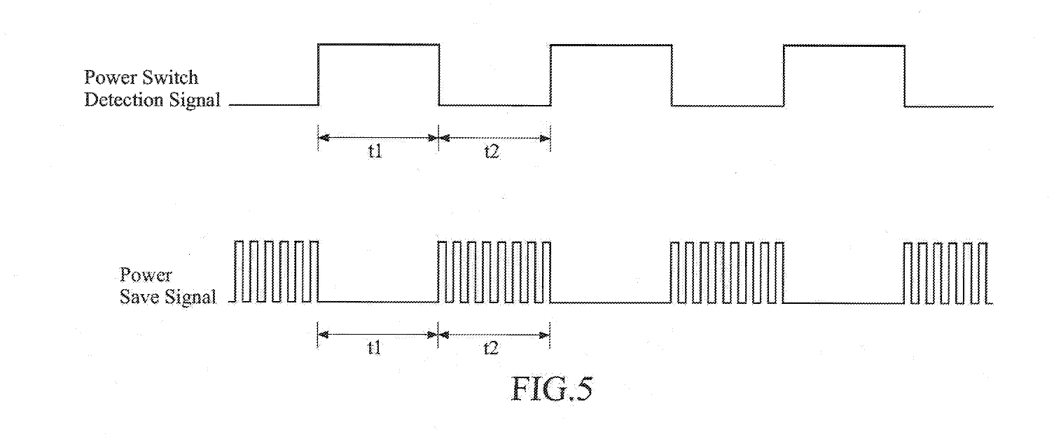

Refer to FIG. 4 and FIG. 5. FIG. 5 is a diagram comparing a power save signal and a waveform of a power switch. The power save unit 111a makes a power switch 114 send a power save signal S1a in the light load mode, wherein a cycle of the power save signal S1a corresponds to a switch state of the power switch 114a. After the control circuit 12a receives the power save unit signal S1a, the switch state is acknowledged. The switch state includes a switch time and a switch pulse number. Besides, the power save unit 111a sends a power switch detection signal S4a to the power switch 114a and the power switch 114a sends the power save signal S1a. Other components in the second embodiment work the same as those in the first embodiment and are not mentioned redundantly here.

For example, when the switch state is a switch time, the switch time is defined as the ratio of switch time and non-switch time of the power switch 114a. Further, as shown in FIG. 5, time interval t1 represents the operation time of the power switch detection signal S4a (high level). During this time interval t1, the power switch 114a stops switching. Time interval t2 represents the power switch detection signal S4a in low level and during time interval t2, the power switch 114a starts to switch. Therefore, the power switch 114a sends the power save signal S1a with a cycle corresponding to the switch time and non-switch time of the power switch detection signal S4a sent from the power save unit 111a. Thus, the control circuit 12a receives the power save signal S1a and a detection signal S2a, obtains the current value of a light load current Ia according to the data table and determines if the current value reaches the threshold, the control circuit 12a simultaneously outputs a switch off signal S3a to the activation input end 113a to switch off the detection process module 11a.

Take the switch state being a switch pulse number for example. Within a unit time interval (t1+t2, according to the second embodiment of the present invention), when the load 2a is lighter, the time interval t2 decreases, so the pulse numbers within the unit time interval also decrease; on the contrary, when the load 2a is heavier, the time interval t2 increases, so the pulse numbers within the unit time interval also increase. Therefore, the power save signal S1a with a cycle corresponding to the pulse number can be output, so the control circuit 12a receives the power save signal S1a and a detection signal S2a, obtains the current value of a light load current Ia according to the data table.

In conclusion, precision amplifiers and sensing resistances are no longer required according to embodiments of the present invention. Instead, merely a data table is required for the detection of light load currents. Thus, the problems of high cost, waste of space and low conversion efficiency no longer bother.

While the present invention has been particularly shown and described with reference to a preferred embodiment, it will be understood by those skilled in the art that various changes in form and detail may be without departing from the spirit and scope of the present invention.

What is claimed is:

1. A light load current detection system detecting a current value of a light load current of a load in a light load mode, the load electrically connecting a switch, the light load current detection system comprising:
a detection process module electrically connecting an input voltage source and electrically connected to the load via the switch, the detection process module including:
a power save unit sending a power save signal in the light load mode, wherein a cycle of the power save signal corresponds to a switch time; and
a voltage detection module electrically connecting the input voltage source for detecting an input voltage value of the input voltage source to generate and output a detection signal;
a control circuit including a data table and a threshold, the data table showing a relation among the cycle, the current value and the input voltage value, the control circuit electrically connecting the power save unit, the voltage detection module and the switch for receiving the power save signal and the detection signal, obtaining the current value according to the data table, the cycle and the input voltage value, and determining whether the current value reaching the threshold, wherein when the control circuit determines the current value reaches the threshold, the switch is turned off in the light load module.

2. The system according to claim 1, wherein the control circuit includes a Micro Control Unit (MCU).

3. The system according to claim 1, wherein the detection process module further includes an activation input end, the control circuit electrically connecting the detection process module via the activation input end, when the control circuit determines the current value reaches the threshold, the control circuit simultaneously outputs a switch-off signal to the activation input end so as to turn off the detection process module.

4. The system according to claim 1, wherein the load is selected from the group of a cellphone, a tablet computer and a laptop computer.

5. A light load current detection system detecting a current value of a light load current of a load in a light load mode, the load electrically connecting a switch, the light load current detection system comprising:
a detection process module electrically connecting an input voltage source and electrically connected to the load via the switch, the detection process module including:
a power save unit electrically connecting a power switch and sending a power save signal via the power switch in the light load module, wherein a cycle of the power save signal corresponds to a switch state of the power switch; and
a voltage detection module electrically connecting the input voltage source for detecting an input voltage value of the input voltage source to generate and output a detection signal;
a control circuit including a data table and a threshold, the data table showing a relation among the cycle, the current value and the input voltage value, the control circuit electrically connecting the power switch, the voltage detection module and the switch for receiving the power save signal and the detection signal, obtaining the current value according to the data table, the cycle and the input voltage value, and determining whether the current value reaching the threshold, wherein when the control circuit determines the current value reaches the threshold, the switch is turned off in the light load module.

6. The system according to claim 5, wherein the switch state includes a switch time and a switch pulse number.

7. The system according to claim 5, wherein the control circuit includes a Micro Control Unit (MCU).

8. The system according to claim 5, wherein the detection process module further includes an activation input end, the control circuit electrically connecting the detection process module via the activation input end, when the control circuit determines the current value reaches the threshold, the control circuit simultaneously outputs a switch-off signal to the activation input end so as to turn off the detection process module.

9. The system according to claim 5, wherein the load is selected from the group of a cellphone, a tablet computer and a laptop computer.
